(19) United States
(12) Patent Application Publication
(10) Pub. No.: US 2002/0057637 A1
(43) Pub. Date: May 16, 2002

(54) PROTECTING A DIGITAL OPTICAL DISK AGAINST COPYING, BY PROVIDING A ZONE HAVING OPTICAL PROPERTIES THAT ARE MODIFIABLE WHILE IT IS BEING READ

(76) Inventor: MAURICE MILGRAM, PARIS (FR)

Correspondence Address: SCHWEITZER CORNMAN GROSS & BONDELL, 230 PARK AVENUE, NEW YORK, NY, 10169

(21) Appl. No.: 09/157,056

(22) Filed: Sep. 18, 1998

(30) Foreign Application Priority Data
Sep. 19, 1997 (FR) 97-11786

(51) Int. Cl. G11B 7/00; G11B 7/24; G06F 12/00

(52) U.S. Cl. 369/53.21; 369/275.3

(57) ABSTRACT

The invention provides a method of providing copy protecting to data recorded on a data medium of the CD-ROM type that is readable by means of a laser beam. Applications thus lie in providing copy protection for digital optical disks (CD-ROM, DVD-ROM, etc.). The medium includes a sensitive zone over at least a portion of its surface, said zone possessing at least one optical property that is modified on being illuminated by the laser beam. The method implies that a computer program using the data reads from the sensitive zone on at least two separate occasions and compares the results of the reads in order to verify that the optical property of the sensitive zone has indeed been modified. The modification to the optical property is maintained for a predetermined duration of modification. The sensitive Zone may cover the entire medium. The optical property that is modified may be index of reflection or polarization. The sensitive zone con be obtained by depositing a layer of a photorefractive material such as lithium niobate.

### BACKGROUND OF THE INVENTION

The present invention relates to protecting CD-ROM type data media against copying, where such protection is becoming more and more necessary now t hat means for duplicating these media (e.g. “burners”) are becoming widespread.

### OBJECT AND SUMMARY OF THE INVENTION

This protection is physical and requires no modification to the hardware of already-installed readers (of which there are several tens of millions).

This protection is based on the principle of using the optical properties of certain materials to create zones on the medium which present a certain amount of memory about reads that have taken place immediately beforehand. These zones make it possible to have,data that behaves dynamically in a way that does not occur on copies recorded on conventional media. Any application software, and in particular installation software making use of the data on the support then needs merely to take advantage of this memory effect.

The term “CD” is used below to cover any data medium that can be read by a laser beam, e.g. of the following types: CD-ROM, CD-audio, CD-R, DVD, DVD-ROM, optical card, etc.

The term “sensitive zone” (SZ for short) is used to designate the portion of the CD which is made of a material having one or more optical properties (transmission coefficient, index of reflection, polarization, . . . ) modified by the read laser beam passing thereover. These materials (referred to below as “MP”) are said to be photorefractive or photochromic, and they present non-linear behavior under high levels of illumination. An example is lithium niobate.

### MORE DETAILED DESCRIPTION

This modification takes effect after the laser beam has passed and it lasts for a duration that may be one millisecond to infinite; this duration is referred to below as the “modification duration” (MD) To simplify, it is assumed that any SZ read during the MD gives a sequence of 0s. These SZs can be obtained by a layer of a special material derived from research into non-linear optics (material that is photochromic, photoresistant, . . . ).

If the MD is infinite, or at least a few months, the method can be used to control the number of copies that have been installed from the same CD. The SZ need not be confined to a single zone of the CD but is advantageously spread about in many places, and it is used indirectly, e.g. to supply a read address or a number of bytes that rare to be read.

An infinite MD can be obtained by using an irreversible change of the material, as happens with the, silver salts used in conventional photography. The irreversible modification to the optical properties (transmission, index, reflection, polarization) of the material under high levels of spot illumination is a simple means for obtaining a MD, and this result can also be obtained by combining various layers having different time constants. An opaque first layer can serve as a mask hiding another layer of the silver salt type, with high intensity illumination causing the opaque layer to be made partially transparent for a period of time that lasts a few seconds.

With a very small MD (typically less than 100 ms), it is possible to design “dynamic data” that it is theoretically impossible to copy directly. Assume that the programs using the data written on the CD proceed by combining the data read from the same location on the CD but at different instants t1 and t2. If t2−t1 is greater than the MD, then the information read on both occasions will be identical; otherwise it can be different. When copying onto a “standard” CD (having no SZ), the same programs will behave in different manner, thereby making the copied CD unusable.

### Using the Dynamic Data Concept in a Program

In general, software publishers using a CD-ROM or some other digital optical disk as a physical medium do not seek to constrain users to keep the CD-ROM in the reader while the software is actually in use. As a result it is general practice to have a procedure for installing the software written on the CD-ROM which transfers the files required for running the software onto the hard disk of the host computer. The presence of the CD-ROM will be required again only for the purpose of reinstalling the software or for adding any modules that were not installed initially.

If the installation program (often called “setup”) makes specific and unavoidable use of certain items of dynamic data written on the CD, then a copy (e.g. an illegal copy) of the CD having an SZ onto a conventional medium (i.e. a CD without an SZ) will not be capable of operating correctly. This assumes that it is difficult, even for an expert, to replace the installation program by another installation program which makes no use of the dynamic aspect of the data. It is probable that if such use were restricted to a few easily-identifiable tests, then such an expert would have little difficulty in avoiding them. This is merely another aspect of the same kind of problem that already exists with hardware computer keys (or “dongles”) and programs said keys supposed to protect against illegal use. It can be considered that a program using this dynamic data principle is protected by a kind of hardware key which is constituted by the ZC used. By way of non-exclusive example, it is possible for a logical condition governing a conditional branch to make use of the result of a comparison between two items of data read from the same location on the CD at a time interval that is known because it is related to the running of the program. It is even possible to read a branch address or an item of data that is used in calculating a branch address at a specific location of the CD which, may or may not have a ZC. Depending on earlier reads, the location will have acquired a determined value and will have a direct influence on the subsequent running of the sequence of instructions.

It can thus be seen that an infinite MD can be used to protect against multiple installations and that a short MD and dynamic data can protect against copying onto another CD or some other medium.

The present invention can thus be summed up by the fact that it includes a sensitive zone on at least a portion of the surface used as a data medium that can be read by a laser beam, said zone possessing at least one optical property that is modified by being illuminated by the laser beam.

The optical property remains in the modified state for a predetermined modification duration. The sensitive zone may cover the entire medium. The modifiable optical property may be its index of reflection or its polarization. It may be obtained by depositing a layer of a photoretractive material such as lithium niobate.

The invention provides a method of providing copy protecting for data recorded on a data medium of CD type that is readable by a laser beam and that complies with one or more of the above characteristics. The method is associated with a computer program for using the data, which program reads the sensitive zone (as described above) on at least two different occasions, and compares the results of such reads to verify that the optical property of the sensitive zone has indeed been modified.

Such reads can be repeated until a given result is obtained, thereby measuring a physical parameter of the sensitive zone, which parameter can be required to lie in a predetermined range.

The program that makes use of the data can thus combine a plurality of reads of the sensitive zone to calculate a particular values the value can then be used in the program, e.g. but not exclusively, to branch to an address or to define the next track to be read on the medium.

1. A data medium of the CD-ROM toe that in readably by a laser beam, the medium including a sensitive zone occupying at least a portion of its area acting as a data medium and that is readable by a laser beam, said zone having at least one optical property that is modified on being illuminated by the read laser beam.

2. A medium according to claim 1, wherein the modified optical property remains modified for a predetermined duration of modification.

3. A medium according to claim 1, wherein said sensitive zone can cover the entire medium.

4. A medium according to claim 1, wherein said modified optical property is transmission coefficient, index of reflection, or polarization.

5. A medium according to claim 1, wherein the sensitive zone is obtained by depositing a layer of photorefractive material such as lithium niobate.

6. A method of providing copy protection to data recorded on a data medium of the CD type that is readable by a laser beam, the method consisting in using as the original data medium a medium according to claim 1.

7. A method according to claim 6, wherein the data is associated with a computer program for using the data, which program reads from the sensitive zone of the medium on at least two different occasions and compares the results of the reads to verify that the optical property of the sensitive zone has been modified.

8. A method according to claim 7, wherein the modified optical property remains modified for a predetermined duration of modification, and the program reads in the sensitive zone several times over until it has obtained a given result, thereby obtaining a measure of a physical parameter of the sensitive zone, which parameter is required to lie within a predetermined range.

9. A method according to claim 7, wherein the program combines the results of reading data in the sensitive zone on two different occasions.
